(19) United States
(12) Patent Application Publication
(10) Pub. No.: US 2004/0139421 A1
(43) Pub. Date: Jul. 15, 2004

(54) Automated methods and systems for generating and updated user-specific industry standards compliance reporting software

(75) Inventor: Angela Michelle Hall, Raleigh, NC (US)

Correspondence Address: JENKINS & WILSON, PA, 3100 TOWER BLVD, SUITE 1400, DURHAM, NC, 27707, US

(73) Assignee: Tekelec

(21) Appl. No.: 10/729,253

(22) Filed: Dec. 5, 2003

Related U.S. Application Data
(60) Provisional application No. 60/431,894, filed on Dec. 9, 2002.

(51) Int. Cl. G06F 9/44

(52) U.S. Cl. 717/101

(57) ABSTRACT

Methods and systems for automatically generating computer code for industry standards reporting are disclosed. A programmer writes core industry standards rules computer code based on industry standards reporting rules. The core industry standards rules computer code is independent of user data formats or locations. A user inputs user-specific data formats and locations in a mapping table that links industry standards reporting rules to the user-specific data formats and locations. A translation script automatically translates the core industry standards rules computer code into user-specific industry standards rules application code based on the data stored in the table. When the industry standards reporting rules change, the core industry standards rules computer code is updated and the translation is re-executed to generate user-specific computer code.

### RELATED APPLICATIONS

This application claims the benefit of U.S. Provisional Patent Application Serial No. 60/431,894, filed Dec. 9, 2002, the disclosure of which is incorporated herein by reference in its entirety.

### TECHNICAL FIELD

The present invention relates to systems and methods for processing and reporting industry metric data. More particularly, the present invention relates to a change management system for fulfilling industry or customer metric reporting requirements without creating additional workload when changes to industry or customer reporting requirements take place.

### BACKGROUND ART

Compliance with industry standards often requires generating periodic reports based on specified reporting rules. For example, TL 9000 is the standard that specifies product quality reporting rules for the telecommunications industry. In other industries, government agencies or standards organizations generate similar reporting rules with which companies must comply in order to receive certification or other regulatory approval. Various computer programs exist to automate the reporting of industry standard metrics. However, none of these automated industry standards report generation programs are capable of efficiently addressing the ever-changing collection and reporting requirements without completely rewriting automation system software.

Another problem with conventional industry-standards reporting software is that each software version is tailored to individual user data formats and locations. As a result, companies must employ a skilled programmer to write new software in accordance with company-specific data formats and locations each time industry standards reporting requirements or company-specific data formats or locations change. Therefore, there exists a long-felt need for an automated industry standards compliance reporting system that is easily updateable when reporting rules or company-specific data formats or locations change.

### DISCLOSURE OF THE INVENTION

The present invention includes methods and systems for automatically generating user-specific software for processing and reporting metrics associated with an industry standard (e.g., the TL 9000 standard, an SEC financial reporting standard, information security standards, pharmaceutical industry measurements standards, etc.). The present invention may include a core rules engine, a user-data-to-metric-data mapping table, and a translator. The core rules engine may include software that contains logic for implementing industry standards reporting rules as defined in the relevant industry standards document. The core rules engine may be updated periodically by a programmer as industry standards reporting rules change. The user-data-to-metric-data mapping table contains links between user-specific data formats and locations and industry standards reporting rules. Because the links are maintained in an easy-to-use table, the links are updateable by the end user. The translator may be software that automatically applies the user-defined links in the table to the core rules application engine to generate a translated core rules application engine. The translated rules engine may be software that is executed to produce industry standards compliance reports based on raw measurements data using the links created by the user.

Because the core rules engine can be updated independently of user data formats and locations, a single core rules engine software version can be created and used to automatically generate user-specific computer code for many different users. In addition, because the user-specific data formats and locations are stored in a table, updates to these formats or locations can be easily updated by each user. As a result, the time and labor required to create and update industry standards reporting software for many different users is reduced.

### BRIEF DESCRIPTION OF DRAWINGS

Preferred embodiments of the invention will now be explained with reference to the accompanying drawings of which:

FIG. 1 is a block diagram of a system architecture for software for generating and updating user-specific industry standards reporting software according to an embodiment of the present invention;

FIG. 2 is a flow diagram illustrating exemplary processing of user data using a translated rules application engine according to an embodiment of the present invention; and

FIG. 3 is a table and computer screen shots illustrating exemplary output produced by automatically created, user-specific industry standards reporting computer code according to an embodiment of the present invention.

### DETAILED DESCRIPTION OF THE INVENTION

A number of industries, including the telecommunications, pharmaceutical, financial and Internet communication industries, have formed standards organizations that oversee the development, collection, and reporting of industry standard metrics. For example, in the telecommunications industry, TL 9000 is the new Industry Standards Organization (ISO) standard for specifying quality requirements for the design, development, production, delivery, and maintenance of products and services. TL 9000 includes performance and cost-based metrics for measuring the reliability and quality of goods and services.

An example of a TL 9000 quality metric is software update quality. The current TL 9000 reporting rule for software update quality requires that the software update be classified as defective if a report from a user indicates that a critical and major failure occurs within six months of the release. However, this counting rule as to what conditions lead to a software update being classified as defective is expected to change with the next release of TL 9000. For example, the counting rule for a software update to be classified as defective is expected to include critical-only failures that occur within three months of the release. In current automated TL 9000 reporting software, such changes require a skilled programmer to update the source code for the reporting software, generate a new executable file, and replace the existing executable file that performs the reporting. Different versions of the executable files must also be created for different users because each user may have different internal data storage location and formats. In addition, each user may desire to generate different customized reports for internal purposes, which requires further customization of each executable file by the programmer. As a result, current industry standards reporting software is inadequate for universal applicability.

The problem of creating universally applicable industry standards reporting software is not limited to the telecommunications industry. For example, in the U.S. pharmaceutical industry, the Food and Drug Administration (FDA) has developed standard metrics based on the types of drug products and whether drugs are new or improved drugs. Example FDA requirements documents include the Guideline for the Format and Content of the Clinical and Statistical Sections of an Application and the Guideline for Submitting Samples and Analytical Data for Methods Validation. These and other FDA reporting guidelines contain reporting rules that change periodically.

The present invention includes methods for self-generating user-specific computer code for meeting ever-changing reporting requirements that can be applied to any industry with changing reporting requirements, including all of the specific examples described herein.

The Chemical Weapons Convention (CWC) is an international treaty that bans chemical weapons and establishes reporting guidelines for compliance with the treaty. An example of such guidelines can be found at http://www.cwc.gov/regulations/frfa/. Such guidelines may change periodically as new chemical weapons threats are identified and new regulations are agreed upon by member nations.

In the United States, the Securities and Exchange Commission (SEC) requires publicly traded companies to periodically generate reports according to the SEC securities regulations. An example an SEC-mandated report is a 10Q report. The contents of these reports may change with changing securities regulations.

In each of the aforementioned industries or reporting areas, compliance reports are required to be generated. The rules for generating such reports periodically change. The present invention allows a single version of the core reporting rules software to be written for multiple users with different data storage formats and locations. A translator automatically translates the core reporting rules software into user-specific reporting rules software based on user-specified data formats and locations.

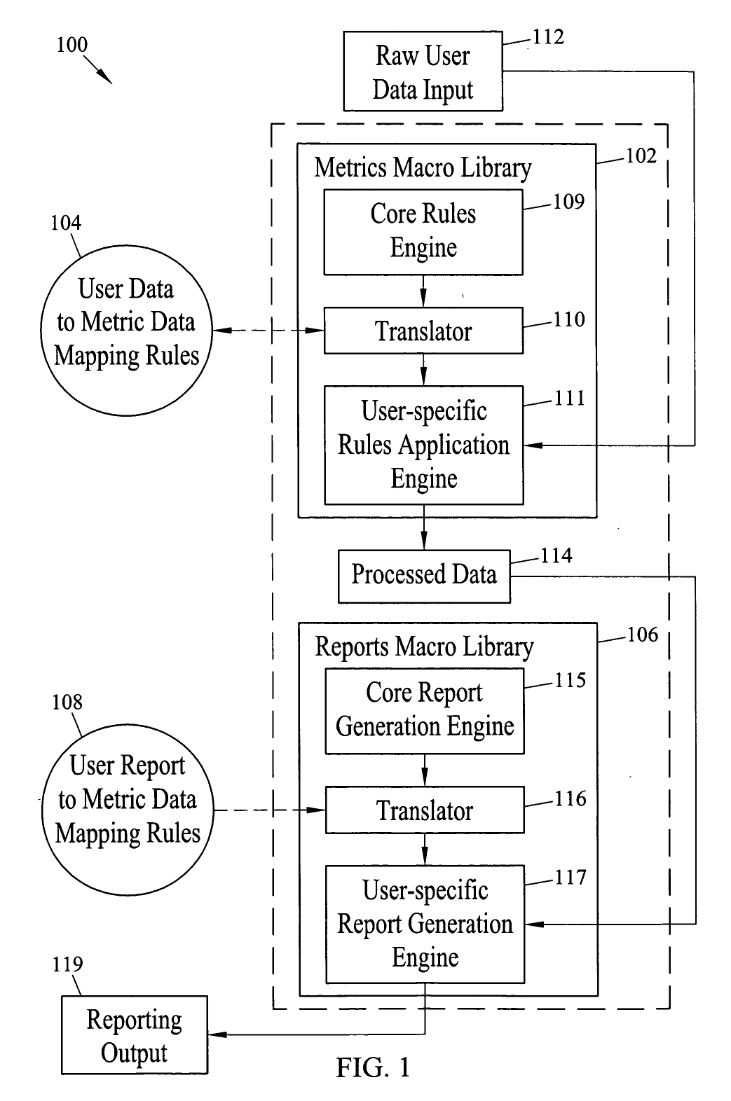

FIG. 1 is a block diagram of a system for automatically generating user-specific industry standards reporting rules computer code according to an embodiment of the present invention. In FIG. 1, the system includes a collection of software modules and data structures, some of which may be updateable by a programmer and others of which may be configurable by the end user. In the illustrated example, system 100 includes a metrics macro library 102, user-data-to-metric-data mapping rules 104, a reports macro library 106, and user-report-to-metric-data mapping rules 108. Metrics macro library 102 may include a core rules engine 109, a translator 110, and a user-specific data processing engine 111. The computer code in core rules engine 109 may implement the core industry standards measurements rules, such as how to count critical events in the TL 9000 standard. User-data-to-metric-data mapping rules 104 include end-user-defined links between industry standards reporting rules and user-specific data formats and locations. In the illustrated example, for each industry standards reporting rule, the links indicate where the data for that rule is stored on the user's system, the data type, and the user data variable names that correspond to the industry standard variable names.

Translator 110 translates the rules defined in core rules engine 109 into user-specific computer code, illustrated by user-specific rules application engine 111, based on the user-data-to-metric-data mapping rules 104. User-specific rules application engine 111 may receive raw user data 112 as input and produce processed data 114 as output. Processed data 114 may include required industry standards measurements stored in readily accessible format, such as a spreadsheet or a comma-separated text file.

Because the user-specific data formats and locations are decoupled from the core data processing engine, a programmer can maintain the computer code in core reporting engine 109 in metrics macro library 102 based solely on changes in the industry standard. The programmer is not required to know user-specific data formats, locations, or variable names. As a result, the system illustrated in FIG. 1 can be easily updated for multiple different users who store data in different formats or locations and who use different variable names.

Reports macro library 106 and user-data-to-metric-data report creation rules 108 are similar in function to metrics macro library 102 and user-data-to-metric-data mapping rules 104. For example, reports macro library 106 may contain a core report generation engine 115 that generates reports according to industry standards specific report format rules, a translator 116 that translates the industry standards report generation rules into a user-specific report generation engine 117 using user-report-to-metric-data mapping rules 108.

User to user-report-to-metric-data mapping rules 108 may include user-defined links between user data and the corresponding industry standard report format variables or rules. The result of applying the translated code to processed data 112 is a customized report indicated by block 119.

Table 1 shown below illustrates an example of user-data-to-metric-data mapping rules 104 according to an embodiment of the present invention.

TABLE 1
Sample User-data-to-metric-data Mapping Rules

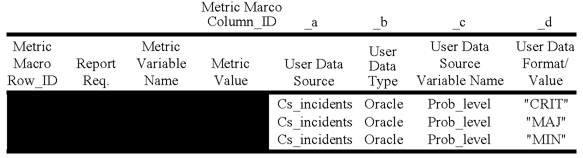

The user-data-to-metric-data mapping rules illustrated in Table 1 may be accessible and updateable by the user using any suitable interface, such as a web interface. The user-customizable fields are indicated by the un-shaded portion of Table 1. In the illustrated example, these fields include User Data Source, User Data Type, User Data Source Variable Name, and User Data Format/Value. These fields indicate how a particular user stores and formats raw measurements data. Each combination of these fields may be linked to fields defined in an industry standards document. These industry standards fields are indicated by the shaded portion of Table 1. As will be explained in more detail below, the data illustrated in Table 1 may be used to generate customized computer code based on core code in metrics macro library 102.

Each industry standards reporting specification (e.g., TL 9000) will define the reporting requirements for each measurement. The report requirement and filter variable name fields correspond to requirements in specific sections in the relevant industry standards documents. The variables stored in these fields are used by algorithms in metrics macro library 102 to store and calculate the relevant measurements. The combination of the metrics macro row ID column and the metric macro column ID row in Table 1 is utilized to uniquely represent each user defined item in the Table. The user defined item then replaces the metric macro in the dynamic code to create specific code for the particular user requirements.

As stated above, the user-data-to-metric-data mapping rules in Table 1 may be used to create customized industry standards reporting computer code. Referring again to Table 1, for each industry standard parameter indicated in the shaded portion of the table, a user need only specify the relevant user data source, type, name, and format information. For example, certain reporting requirements of the TL 9000 standard dictate that “problem” data be collected and maintained. The first row in Table 1 corresponds to a user-defined relationship or link, which specifies how “critical problem” data may be obtained from raw user data stored in a user-specified format and location. More particularly, the mapping in row 1 of the table specifies that the “Problems” metric includes a filter variable called “Severity.” In the context of the “Problems” metric, one of the possible “Severity” filter variable values is “CRITICAL.” The metric “Severity” filter and associated “CRITICAL” value correspond to a user defined value of “CRIT,” which is stored within a user defined data set “Cs_incidents,” in a user defined variable called “Prob_level.” With regard to user data source variable names, it will be appreciated that the relative location of a particular variable data source (e.g., spreadsheet cell address, column offset, etc.) can also be specified.

Using the table-driven architecture of the present invention, a user may quickly and easily map or link user data to the set of defined, standard report metrics, filters, and variables. As user input data formats change these changes can be easily accommodated by changing the appropriate user variables in Table 1. In a similar manner, as industry standard reporting variables or values change, these changes can be made by changing the appropriate metric variables in Table 1. Changes in the reporting rules can be accomplished through effecting changes to core rules engine 109. The decoupling of reporting rules from user data formats and locations decreases the time and skill required to generate customized industry standards reporting software.

With regard to user data sources, the present invention may access user data that is stored in a variety of formats. For example, user data may be accessed in an Oracle data structure, any number of spreadsheet formats, a comma or space separated text format, as well as any other data formats utilized by a user to store data. In one embodiment, the present invention may employ an Open Database Connectivity (ODBC) interface, which is a widely accepted application programming interface (API) for database access that uses Structured Query Language (SQL) as its database access language.

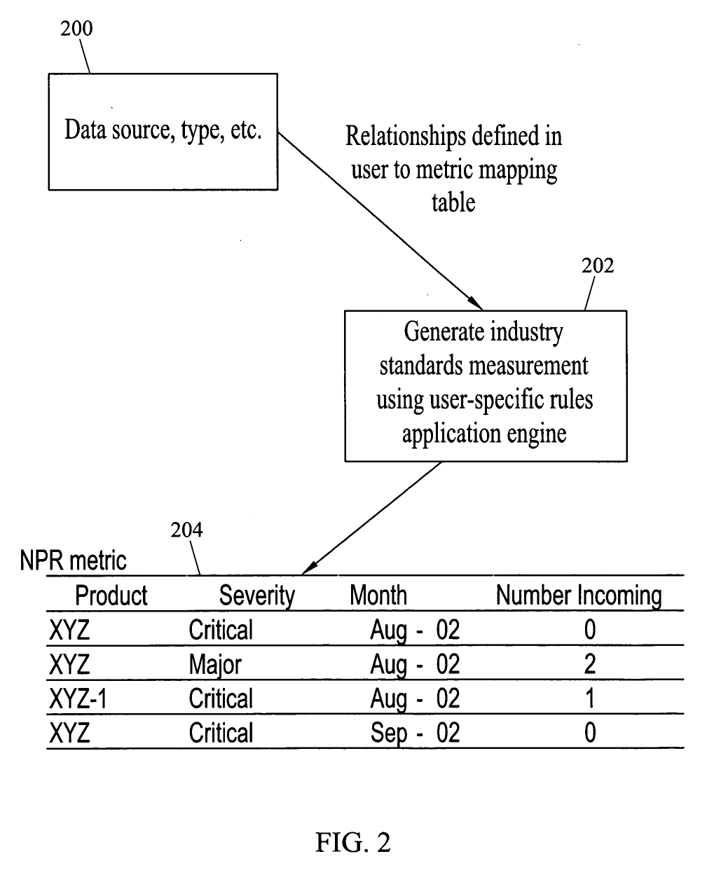

Once raw data 112 has been transformed into processed data 114 by user-specific rules application engine 111, processed data 114 can be stored and used for report generation. FIG. 2 is a flow diagram illustrating exemplary processing of raw user data using a user-specific rules application engine 111 according to an embodiment of the present invention. In FIG. 2, block 200 represents the rules defined in user-data-to-metric-data mapping rules 104. Block 202 represents the application of user-specific rules application to the user data. Block 204 represents an industry standard summary report that may be generated by user-specific rules application engine 111.

The following computer code is an example of untranslated and translated core reporting rules according to an embodiment of the present invention. In the computer code that follows, the left-hand column represents untranslated reporting rules, and the right-hand column represents translated reporting rules. Thus, core rules engine 109 may be implemented using the computer code in the left-hand column, and user-specific rules application engine 111 may be implemented using the rules in the right-hand column.

METRIC MACRO LIBRARY PROGRAM
data critical;
set &npr1_a;
where &npr1_c = &npr1_d;
run;
data major;
set &npr2_a;
where &npr2_c = &npr2_d;
run;
data minor;
set &npr3_a;
where &npr3_c = &npr3_d;
run;
/*combine above*/
data all;
set critical major minor;
run;
/*calculate number of events
each severity occurs*/
proc freq data=all noprint;

tables sev / noprint

out=srcefreq;
run;
/*rename variables for future
use*/
data npr;

set srcefreq;
if sev=&npr1_d; then NP2=COUNT;
else if sev=&npr2_d then

NP3=COUNT;

else if sev=&npr3_d then

NP1=COUNT;
run;
/*add consolidated information
into data storage location
calculate according to industry
standards*/
data tl9000.npr;

set tl9000.npr sumnpr;
if NP1 = . then NP1 = 0;
if NP2 = . then NP2 = 0;
if NP3 = . then NP3 = 0;
NPR1=NP1/NIS;
NPR2=NP2/NIS;
NPR3=NP3/NIS;
Critical=NPR1*&npra;
Major=NPR2*&npra;
Minor=NPR3*&npra;

run;
TRANSLATED PROGRAM BASED ON
USER-DATA-TO-METRIC-DATA MAPPING
data critical;
set cs_incidents;
where Prob_level = “CRIT”;
run;
data major;
set cs_incidents;
where Prob_level = “MAJ”;
run;
data minor;
set cs_incidents;
where Prob_level = “MIN”;
run;
data all;
set critical major minor;
run;
proc freq data=all noprint;

tables sev / noprint

out = srcefreq;
run;
data npr;

set srcefreq;
if sev“CRIT” then NP2=COUNT;
else if sev=“MIN” then

NP3=COUNT;

else if sev=“MIN” then

NP1 = COUNT;
run;
data tl9000.npr;

set tl9000.npr sumnpr;
if NP1 = . then NP1 = 0;
if NP2 = . then NP2 = 0;
if NP3 = . then NP3 = 0;
NPR1=NP1/NIS;
NPR2=NP2/NIS;
NPR3=NP3/NIS;
Critical=NPR1*12;
Major=NPR2*12;
Minor=NPR3*12;

run;

From the computer code above, it can be seen that the code in the left-hand column can be written based on industry standards reporting rules only without regard to user data formats or storage locations. The translated computer code in the right-hand column contains user-specific data locations and formats based on the data in user-data-to-metric-data mapping table 104. The separation of industry standards requirements and user data formats and locations allows a single version of the industry standards code to be written to satisfy the requirements of multiple users.

The source code shown below is an example of a translator that translates the industry standards rules in the left-hand column above to the user-specific format in the right-hand column above.

/* bring in the rules table */
PROC IMPORT OUT= WORK.rules

DATAFILE= “C:\temp\rules.xls”
DBMS=EXCEL2000 REPLACE;

GETNAMES=YES;

RUN;
/* remove unnecessary rows */
data work.rules;
set work.rules (keep=id _a _b _c _d);
run;
/* assign a macro to each change in id and column */
DATA _NULL_;
set work.rules;
format var $12. y $2.;
/* i=1 is the id column */
do i = 2 to 5;

| if i=2 then do; y=‘_a’; var=_a; end; | |
|---|---|
| else if i=3 then do; | y=‘_b’; var=_b; end; |
| else if i=4 then do; | y=‘_c’; var=_c; end; |
| else if i=5 then do; | y=‘_d’; var=_d; end; |

/* macro assignment id = npr1, npr2, npr3,

y = _a, _b, etc
var= user defined */

call symput(trim(right (id))||trim(left(y)), var);

end; run;
Output:
/* test macro terms for example */
%put &npr1_a; %put &npr1_b; %put &npr1_c; %put &npr1_d;

cs_incidents oracle prob_level “CRIT”

It will be appreciated that any number of other computer programming languages could be used to provide the necessary metric processing functionality, such as C, Visual Basic, JAVA, etc.

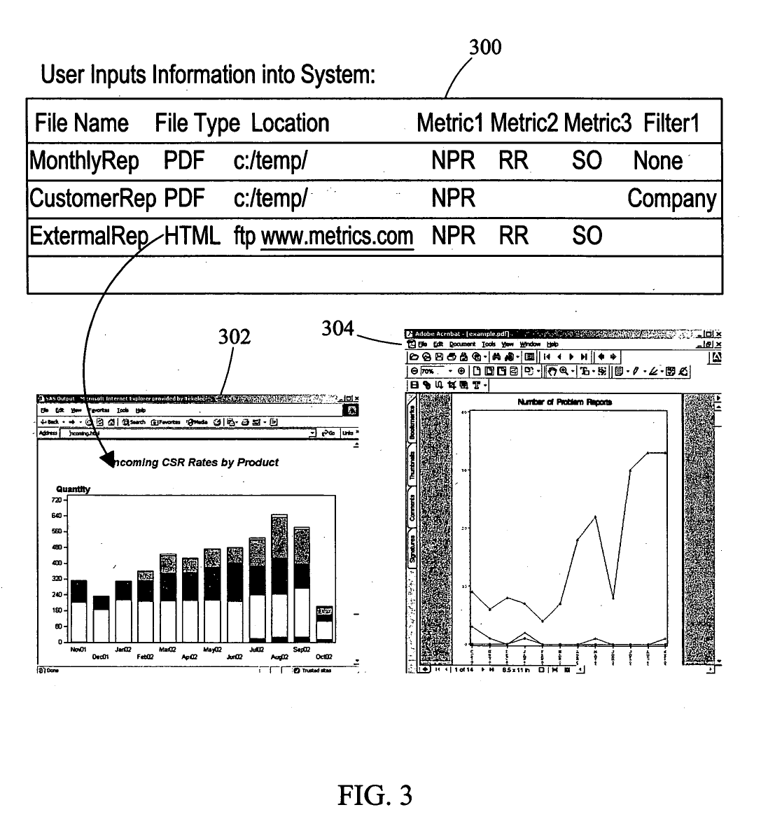

As stated above with regard to FIG. 1, user-report-to-metric-data mapping rules 108 allow end users to define report formats tailored to their individual needs. In one exemplary implementation, user-to-report-to-metric-data mapping rules 108 may allow a user to change report formats using a report list. FIG. 3 illustrates an exemplary report list and corresponding output formats. Referring to FIG. 3, user-report-to-metric-data mapping rules 108 may include a report list 300 that associates user-specific reports with industry standard variables. In the illustrated example, report list 300 includes a file name field, a file type field, a file storage location field, a first included metric field, a second included metric field, a third included metric field, and a reporting filter field. As shown in the first entry of report list 300, a user has defined a first report that is to be stored in an Adobe® PDF-formatted report output file named MonthlyRep. The MonthlyRep.PDF file will be written to the c:/temp/ directory of a data storage device, such as a magnetic or optical disk. This report will include the three metric components, “NPR”, “RR”, and “SO”. No filter additional filter criteria are applied to this report. The second entry in report list 300 includes a different report format that may be generated for a customer. The third entry in report list format may specify an HTML format for reports to be published externally. In FIG. 3, report 302 is an example of a report generated for external purposes that corresponds to the third entry in report list 300. Report 304 is an example of an internal report, that may correspond to either the first or second entries in report list 300. Thus, by using a table driven approach, report formats can be easily updated by a customer with translating the core computer code for implementing industry standards reporting metrics.

Table 2 shown below is another example of data that may be specified by the user as part of user-to-metric report creation rules 108. Table 2 illustrates report formats that may be entered by the user to define needed reports, the measurements to be included in each report, and filters for defining data to be included in each report.

TABLE 2
User-Defined Report Creation Rules

| | Metric Macro Column_ID | | | | | |
|---|---|---|---|---|---|---|
| Metric Macro | _a | _b | _c | _d | _e | _f |
| Row_ID | Report Type | Report Storage Location | Metric1 | Metric2 | Metric3 | Filter1 |
| rep1 | PDF | C:/temp/monthly report.pdf | NPR | RR | SO | |
| rep2 | PDF | C:/temp/customer report.pdf | NPR | SO | | Company = |
| | | | | | | ACE |
| rep3 | HTML | www.metrics.com/reports.html | NPR | | | |

Returning to FIG. 1, translator 116 translates computer code in core reporting engine 115 to produce user-specific report generation engine 117 based on user-report-to-metric-data mapping rules 108, such as those illustrated in report list 300 in FIG. 3 or in Table 2 above. The following computer code illustrates an example of a core report generation engine and a user-specific report generation engine according to an embodiment of the present invention. In particular, the left hand column illustrates a core report generation engine and the right hand column illustrates a user-specific report generation engine. Translation code, similar to the translation code set forth above may be used to generate the code in the right hand column from the code in the left hand column based on user-specified rules in table 108.

OUTPUT MACRO LIBRARY PROGRAM
%macro report (type, loc,
metric1, metric2, metric3,
filter1);
/*determine which report to
run*/
%if type = ‘PDF’ %then %do;

goptions device=pdf;
ods printer pdf

file=“&&loc;”;

%end;

```
%if type = ‘HTML’ %then %do;
data_null_;
filename=SCAN(“&&loc”, 2, ‘/’);
location=SCAN(“&&loc”, 1, ‘/’);
call symput (‘file’, filename);
call symput (‘loc’, location);
run;
goptions device=activex;
filename outpt ftp
“&&file” host=“&&loc”
user=username
pass=userpassword;
ods html body = outpt; %end;
/*output metrics*/
%if metric1 \hat{ }= ‘’ %then %do;
call
execute (‘%’||trim(left(&metric1
))||‘(’||trim(left(&filter1))||
‘)’); %end;
%if metric2 \hat{ }= ‘’ %then %do;
call
execute (‘%’||trim(left(&metric2
))||‘(’||trim(left(&filter1))||
‘)’); %end;
%if metric3 \hat{ }= ‘’ %then %do;
call
execute (‘%’||trim(left (&metric3
))||‘(’||trim(left(&filter1))||
‘)’); %end;
/*close report*/
%if type =‘PDF’ %then %do;
  ods printer pdf close; %end;
%if type = ‘HTML’ %then %do;
  ods html close; %end;
%mend;
EXAMPLE OF MACRO SPECIFIC TO
ONE REPORT
%macro NPR(filter);
<code removed for filter>
title1 ‘Number of Problem
Reports’;
proc gplot data=npr;
vbar month*count=severity;
```

run;quit;

title2 ‘Raw Data’;
proc report data=npr;
columns severity month count;

define severity/group;
define month/width=6

order=internal;

define count/width=5;
run;quit;

%mend;
TRANSLATED PROGRAM BASED ON
USER-DATA-TO-OUTPUT-REPORT
MAPPING
goptions device=pdf;

ods printer pdf

file=“C:/temp/monthly
report.pdf”;

%NPR;
%RR;
%SO;
ods printer pdf close;

goptions device=pdf;

ods printer pdf

file=“C:/temp/customer
report.pdf”;

%NPR (company=ACE);
ods printer pdf close;

goptions device=activex;

filename outpt ftp
“reports.html”
host=“www.metrics.com”

user=username
pass=userpassword;
ods html body = outpt;

%NPR;

ods html close;

Thus, the present invention includes automated methods and systems for updating industry standards compliance reporting. According to one aspect, a core rules engine contains a computer code that is updatable by a programmer. The core rules engine may be directed to reporting requirements associated with an industry standard. A user-data-to-metric-data mapping table links end user-specific data formats and locations to the rules defined in the core rules engine. A translator translates the computer code in the core rules engine to user-specific industry standards report application computer code based on the links in the user-data-to-metric-data mapping table.

By separating the core rules engine and the user specific data formats and locations, the present invention enables core rules engine code to be more easily developed for many different end users. In addition, by providing a user-data-to-metric-data mapping table that is updateable by an end user, changes to user-specific data formats and locations do not require a programmer for implementation. Finally, by providing a translator that translates the core code into user-specific code, the end user can generate his or her own user-specific industry standards reporting computer code.

It will be understood that various details of the invention may be changed without departing from the scope of the invention. Furthermore, the foregoing description is for the purpose of illustration only, and not for the purpose of limitation, as the invention is defined by the claims as set forth hereinafter.

What is claimed is:

1. A system for automatically generating user-specific industry standards reporting computer code, the system comprising:
(a) a core rules engine containing computer code implementing industry standards reporting rules, the core rules engine being updateable by a programmer based on changes to the industry standards reporting rules;
(b) a user-data-to-metric-data mapping data structure including end-user defined links between user-specific data formats and locations and the rules defined in the core reporting engine; and
(c) a translator for translating the computer code in the core rules engine to user-specific industry standards rules application computer code based on the links in the user-data-to-metric-data mapping data structure.

2. The system of claim 1 wherein the computer code in the core rules engine is based only on industry standards reporting requirements.

3. The system of claim 1 wherein the computer code in the core rules engine is independent of the user data formats and locations.

4. The system of claim 1 wherein the industry standards reporting rules include TL 9000 reporting rules.

5. The system of claim 1 wherein the industry standards reporting rules include financial industry standards reporting rules.

6. The system of claim 1 wherein the industry standards reporting rules include pharmaceutical industry standards reporting rules.

7. The system of claim 1 wherein the user-data-to-metric-data mapping data structure associates end user variable names with variable names used in the computer code of the core rules engine.

8. The system of claim 1 wherein the user-data-to-metric-data mapping data structure comprises a table.

9. The system of claim 1 wherein the computer code in the core rules engine is in source code format and wherein the translator is adapted to translate the computer code in the core rules engine into the user-specific computer code, which is also in source code format.

10. The system of claim 1 comprising a core report generation engine for implementing industry standards reporting rules.

11. The system of claim 10 comprising a user-report-to-metric-data mapping data structure for mapping user-specific report formats to industry standard variable names, wherein the translator is adapted to translate the computer code in the core report generation engine to user-specific computer code based on the user-report-to-metric-data mapping table, wherein a user generates processed data in industry standard format by applying the rules application computer code to raw measurements data and wherein the user generates customized reports by applying the user-specific report generation computer code to the processed data.

12. The system of claim 1 comprising a web interface for providing end user access to the user-data-to-metric-data mapping data structure.

13. A method for generating user-specific computer code for industry standards report generation, the method comprising:
(a) providing core industry standards rules computer code based on core industry standards reporting rules;
(b) providing a user-data-to-metric-data mapping data structure including end-user-modifiable fields for linking user-specific data formats and locations to the core industry standards reporting rules in the core industry standards reporting computer code; and
(c) automatically translating the core industry standards rules computer code into user-specific industry standards rules computer code using the links defined in the user-data-to-metric-data mapping data structure.

14. The method of claim 13 wherein providing core industry standards rules computer code based on industry standards reporting rules includes providing core industry standards rules computer code that is independent of user-specific data formats and locations.

15. The method of claim 13 wherein providing core industry standards rules computer code based on industry standards reporting rules includes providing core industry standards rules computer code that is based only on industry standards reporting rules.

16. The method of claim 13 wherein providing core industry standards rules computer code includes providing core industry standards computer code based on telecommunications industry standards reporting rules.

17. The method of claim 13 wherein providing core industry standards reporting computer code based on industry standards reporting rules includes providing core industry standards reporting computer code based on financial industry standards reporting rules.

18. The method of claim 13 wherein providing core industry standards rules computer code based on industry standards reporting rules includes providing core industry standards reporting computer code based on pharmaceutical industry standards reporting rules.

19. The method of claim 13 wherein providing a user-data-to-metric-data mapping data structure includes providing a user-data-to-metric-data mapping table that is modifiable by an end user.

20. The method of claim 13 wherein automatically translating the core industry standards rules computer code in to user-specific industry standards rules application computer code includes executing a translation script that generates the user-specific industry standards rules computer code based on links in the user-data-to-metric-data mapping data structure.

21. The method of claim 13 comprising updating the user-specific industry standards rules computer code by replacing the core industry standards rules application computer code with a new version based on new industry standards reporting rules and re-executing the translation step.

22. The method of claim 13 comprising applying the user-specific industry standards rule application computer code to user data to produce processed data in accordance with industry standards reporting rules.

23. The method of claim 22 comprising:
(a) providing a core report generation engine for generating reports in accordance with industry standards report requirements;
(b) providing a user-report-to-metric-data mapping data structure containing rules for mapping user-specific report formats to industry standards variables;
(c) automatically translating the core report generation engine into a user-specific report generation engine using the user-report-to-metric-data mapping data structure; and
(d) applying the user-specific report generation engine to the processed data to generate user-specific reports.

24. A computer program product comprising computer executable instructions embodied in a computer readable medium, the computer program product comprising:
(a) first computer code for implementing industry standards data collection rules;
(b) a first data structure including user-data-to-metric-data mapping rules mapping user data sources and locations with industry standards metrics; and
(c) second computer code for translating the first computer code into user specific rules application computer code based on the user to data mapping rules in the user-data-to-metric-data mapping data structure.

25. The computer program product of claim 24 wherein the first computer code implements TL 9000 reporting rules.

26. The computer program product of claim 24 wherein the first data structure includes fields that are customizable by an end user when user data format or location changes.

27. The computer program product of claim 24 wherein the second computer code is usable by a plurality of different end users with different user-data-to-metric-data mapping data structures to generate user specific report generation computer code tailored to each individual end user.

28. The computer program product of claim 24 comprising:
(a) third computer code for implementing industry standards reporting rules; and
(b) a second data structure including user-report-to-metric-data mapping rules, and wherein the second computer code is adapted to translate the third computer code into user-specific report generation computer code based on the user-report-to-metric-data mapping rules in the second data structure.
